(19) United States
(12) Patent Application Publication
(10) Pub. No.: US 2006/0090325 A1
(43) Pub. Date: May 4, 2006

(54) Vehicle powertrain joints comprising self-tapping fasteners

(76) Inventors: Jeremy R. Bernard, St. Charles, IL (US); Donald R. Van Der Moere, Spencer, IN (US); John L. Cagney, Downers Grove, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 10/979,826

(22) Filed: Nov. 2, 2004

(51) Int. Cl. B23P 11/00

(52) U.S. Cl. 29/525.01

(57) ABSTRACT

A method for fastening components (18, 20) at critical joints in a motor vehicle powertrain (24). An unthreaded hole (22) is provided in a first component part (20), and a clearance hole (16) in a second component part (18). The shank (14) of a screw (10) that has a multi-lobed lead capable of creating a thread in the unthreaded hole is passed through the clearance hole to engage the multi-lobed lead with the unthreaded hole. Axial force and rotary torque are applied to the screw to cause the lead to form a desired helical thread in the unthreaded hole.

### FIELD OF THE INVENTION

This invention relates to powertrains of motor vehicles and is particularly concerned with the use of self-tapping fasteners to create certain critical joints in certain parts. Principles of the invention can be embodied in certain engine parts and/or parts in a drivetrain through which the engine is coupled to driven wheels that support the vehicle on an underlying surface.

### BACKGROUND OF THE INVENTION

A motor vehicle powertrain comprises a succession of components through which power is transmitted to the driven wheels that propel the vehicle along an underlying surface. The components begin with pistons that reciprocate within cylinders in the engine. The pistons are connected by connecting rods to the engine crankshaft. A flywheel attaches to the crankshaft and provides an input from the engine to the drivetrain that extends from the engine to the driven wheels.

The drivetrain typically includes a transmission, driveshaft, and axle. Driven wheels are at the ends of the axle. The axle comprises a differential to which one end of the driveshaft connects. The opposite end of the driveshaft connects to an output shaft of the transmission. In the case of a manual transmission, the transmission is coupled to the engine crankshaft at the flywheel through a clutch. In the case of an automatic transmission, the transmission is coupled to the engine crankshaft at the flexplate through a torque converter.

The various components through which power flows from the engine cylinders to the driven wheels are connected in succession from the pistons to the driven wheels. Certain connections use threaded fasteners, such as screws, to form the joint that connects one component to the next. Examples of joints that use threaded fasteners are: 1) the joint between a connecting rod and crankshaft throw; 2) the joint between the crankshaft and crankshaft flange; and 3) the joint between the crankshaft and crankshaft damper 4) the joint between the crankshaft flange and flywheel/flexplate. A joint connecting parts in a motor vehicle powertrain is a critical joint if failure of the joint would damage the powertrain in a way that would render the powertrain incapable of propelling the vehicle.

Where screws are used in creating such joints, the historical practice has been to drill, ream, and then tap each hole into which a screw is to be threaded. Drilling and tapping are separate devoted operations in the manufacturing process. Such tapping of a hole that is used to join parts at a critical joint has been accepted as necessary in order to assure integrity of the joint over its design life.

The inventors believe that a fundamental change in the historically accepted practice can provide meaningful cost savings without comprising the desired integrity of the joint.

### SUMMARY OF THE INVENTION

The inventors believe that such tapping operations can be avoided by leaving certain holes unthreaded and using certain threaded fasteners to tap those holes as the fasteners are being turned into the holes to join one component part to another. The inventors have discovered that a certain type of self-tapping screw can create a suitable thread in an unthreaded hole for assuring joint integrity for operational and environmental conditions that powertrain components encounter in a motor vehicle.

One example of a self-tapping screw that is suitable for purposes of the invention incorporates technology licensed under the trade name TAPTITE® or the trade name TAPTITE 2000®. Both TAPTITE® and TAPTITE 2000® screws are characterized by their licensor, Research & Manufacturing Engineering, Inc., as embodying the Trilobular® principle. The TAPTITE 2000® screw further incorporates a radiused thread flank.

The screws are effective to roll threads in unthreaded holes as the screws are being turned into the holes. Physical characteristics of such a screw, meaning for example material, hardness, and size, are selected for suitable use with the particular material of the component containing the unthreaded hole which is to be threaded by the screw.

One generic aspect of the present invention relates to a method for fastening components at critical joints in a motor vehicle powertrain through which power flows from an engine to driven wheels. The method comprises a) providing an unthreaded hole in a first component part, b) providing a clearance hole in a second component part, c) passing a screw that has a multi-lobed lead capable of creating a thread in an unthreaded hole through the clearance hole in the second component part to engage the multi-lobed lead with the unthreaded hole in the first component part, and d) applying axial force and rotary torque to the screw to cause the lead to form a desired helical thread in the unthreaded hole.

Another generic aspect of the invention relates to a joint created by the method just described.

Still another generic aspect relates to a joint that couples a first component part to a second component part in a motor vehicle powertrain through which power flows from an engine to driven wheels. The joint comprises a screw passing through a clearance hole in one of the component parts and having a thread threadedly engaged with the thread of a hole in the other of the component parts created by a multi-lobed lead of the screw.

The foregoing, along with further features and advantages of the invention, will be seen in the following disclosure of a presently preferred embodiment depicting the best mode contemplated at this time for carrying out the invention. This specification includes drawings, now briefly described as follows.

### BRIEF DESCRIPTION OF THE DRAWINGS

FIG. 1 is a longitudinal cross section view showing a fastener at a portion of a critical joint in a motor vehicle powertrain.

FIG. 2 is a transverse cross section view through the fastener of FIG. 1.

FIG. 3 is a fragmentary view of the thread profile of the fastener.

FIG. 4 is a schematic diagram of a motor vehicle powertrain including examples of critical joints.

### DESCRIPTION OF THE PREFERRED EMBODIMENT

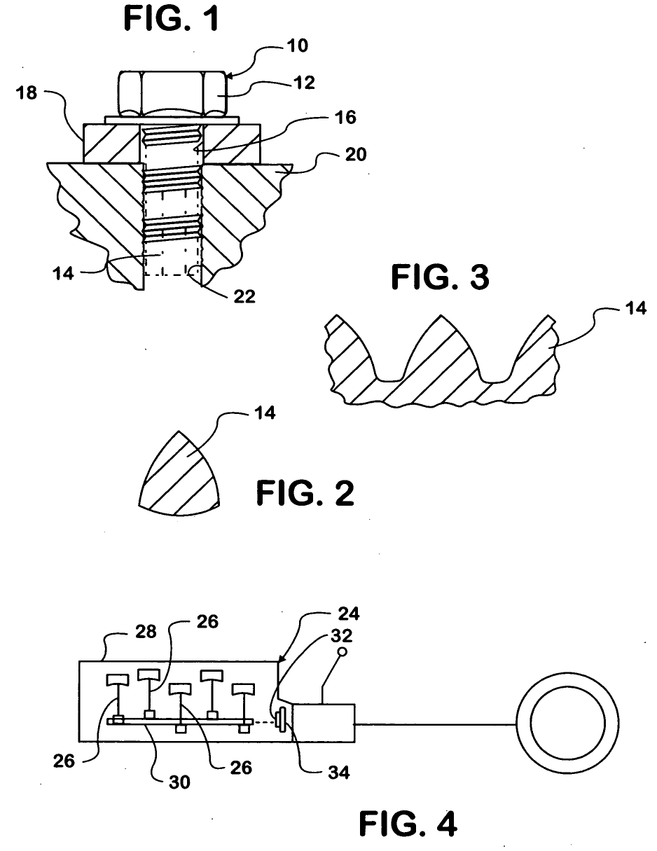

FIGS. 1, 2, and 3 show an example of the present invention at a critical joint. A fastener, specifically a screw, 10 has a head 12 and a shank 14. A clearance hole 16 is provided in a first component part 18 at the joint. A second component part 20 has an unthreaded blind hole 22 before screw 10 is threaded into it.

FIG. 1 shows a threaded portion of shank 14 threadedly engaged with the wall of hole 22 after it has tapped an upper portion of the hole and screw 10 has been tightened. The threaded portion of shank 14 has a trilobular cross section shown in FIG. 2. The profile of the thread shown in FIG. 3 is seen to be radiused.

In a motor vehicle powertrain 24 like that shown in FIG. 4, a critical joint can be, for example, 1) the joint between parts of a connecting rod 26 of an engine 28 where the big end of the rod fits to a throw of the engine crankshaft 30; 2) the joint between the crankshaft and crankshaft flange 32; and 3) the joint between the crankshaft and crankshaft damper; 4) the joint between the crankshaft flange and flywheel/flexplate 34. A joint connecting parts in a motor vehicle powertrain is a critical joint if failure of the joint would damage the powertrain in a way that would render the powertrain incapable of propelling the vehicle.

A screw that is used to join parts at a critical joint, such as screw 10, has, when tightened, a thread engagement of at least 1.5 times the thread diameter, often 1.5 to 2.0 times. One distinguishing aspect of a self-tapping (self-threading) screw that is used in practice of the invention is that the shank threads are rolled, heat treated, and then re-rolled after heat treat. For effectively rolling the thread, the distal end of the screw has a lead that allows it to be started into a drilled hole. Proximal to the lead is the helical tapping thread, having the characteristics mentioned above, that rolls the thread in the wall of the drilled hole after the lead has started the screw in the hole.

The drilled hole is toleranced closely to provide a certain closely controlled dimensional relationship to the crests of the screw thread. The screw thread is multi-lobular, such as the tri-lobular threads of screws incorporating TAPTITE® or TAPTITE 2000® technology.

Certain factors that bear on use of self-tapping fasteners at critical joints in accordance with the invention call for particular steps in the fastening process. Because significant heat is generated as metal is being displaced, a coolant is directed onto the screw as it is being turned. The coolant should also provide some lubrication.

Because of the need for thread engagement of at least 1.5 times the thread diameter, the screw is initially run-down only partially into the hole and then backed off. Further run-down and backing off may occur before final tightening to create the proper screw tension for yielding the desired clamping force at the critical joint.

While a presently preferred embodiment of the invention has been illustrated and described, it should be appreciated that principles of the invention apply to all embodiments falling within the scope of the following claims.

What is claimed is:

1. A method for fastening components together at critical joints in a motor vehicle powertrain through which power flows from an engine to driven wheels, the method comprising:
providing an unthreaded hole in a first component part;
providing a clearance hole in a second component part;
passing a helically threaded screw that has a multi-lobed lead capable of starting the screw in an unthreaded hole in the first component part through the clearance hole in the second component part to engage the multi-lobed lead with the unthreaded hole in the first component part and turning the screw, with an axial force applied, to start it in the unthreaded hole; and
continuing to turn the screw to cause threads that are distal to the lead to create a desired helical thread in the unthreaded hole, wherein the final thread engagement is at least 1.5 times the diameter of the screw thread.

2. The method of claim 1, including causing a portion of the helical thread of the screw that trails the multi-lobed lead to roll the flanks of the thread created in the hole by the multi-lobed lead.

3. The method of claim 2, in which the step of causing a portion of the helical thread of the screw that trails the multi-lobed lead to roll the flanks of the thread created in the hole by the multi-lobed lead comprises rolling the flanks to a radiused profile.

4. A critical joint in a motor vehicle powertrain made by the method of claim 1.

5. A critical joint in a motor vehicle powertrain made by the method of claim 2.

6. A critical joint in a motor vehicle powertrain made by the method of claim 3.

7. A critical joint that couples a first component part to a second component part in a motor vehicle powertrain through which power flows from an engine to driven wheels, the joint comprising an attaching screw passing through a clearance hole in one of the components and having a thread threadedly engaged with a hole in the other of the components created the attaching screw, or by an identical screw, wherein the attaching screw comprises a multi-lobed lead at its distal end and a helical thread that trails the lead, wherein the helical thread has a length of engagement with the hole in the other of the component parts that is at least 1.5 times the diameter of the helical thread.

8. The joint of claim 7 in which a portion of the helical thread of the attaching screw that trails the multi-lobed lead comprises to a radiused profile engaged with a complementary radiused profile in the thread of the hole.

9. The joint of claim 7, in which the components comprise respective components of connecting rod forming a joint with a crankshaft throw.

10. The joint of claim 7, in which the components comprise a crankshaft and a crankshaft flange.

11. The joint of claim 7, in which the components comprise a crankshaft and a crankshaft damper.

12. The joint of claim 7, in which the components comprise a crankshaft flange and a flywheel/flexplate.
